(19) United States
(12) Patent Application Publication
(10) Pub. No.: US 2008/0319840 A1
(43) Pub. Date: Dec. 25, 2008

(54) METHOD AND APPARATUS FOR REAL-TIME TV ADVERTISEMENT AUCTION IN A TV-OVER-IP ENVIRONMENT

(75) Inventors: Qiang Li, Campbell, CA (US); William X. Huang, San Ramon, CA (US); Naxin Wang, Cupertino, CA (US)

Correspondence Address: UTSTARCOM, INC.;c/o Laura Weiss, Paralegal, 3800 Golf Road, Suite 220, Rolling Meadows, IL, 60008, US

(73) Assignee: UTSTARCOM, INC., Alameda, CA (US)

(21) Appl. No.: 11/765,959

(22) Filed: Jun. 20, 2007

(51) Int. Cl. G06Q 30/00; G06Q 40/00

(52) U.S. Cl. 705/14; 705/37

(57) ABSTRACT

A system for real time auctioning of advertising timeslots for live TV transmission over IP networks incorates settop boxes interconnected to a searver to provide real time viewing statistics to an advertising management system which also receives subscriber information from a subscriber management system which also management system determines demographics responsive to the subscriber information and viewing statistics and publishes advertising timeslot information and the determined demongraphics. A management terminal is employed for creating user accounts, providing access information to users, inspecting and approving advertisements responsive to input the advertisements from the users. Bid parameters are defined using the management terminal and the publication by the system to the users is responsive to the bid parameters. User terminals are provided for uploading advertisements to the advertising management system and the advertising management system further assigns unique identification to the uploaded advertisements. The user terminals upload advertising parameters, receive the published time slots and demographics and submit bids to the advertising management system. The advertising management system receives the bids and inserts predefined advertisements responsive to a winning bid.

### BACKGROUND OF THE INVENTION

1. Field of the Invention

This invention relates generally to the field of TV over IP services and more particularly to distribution of live TV programming in a TV-Over IP environment and employing the data available to create and present real-time auctioning of advertising blocks based on immediate viewer data detection.

2. Related Art

Providing live TV broadcast through broadband IP networks has become a viable approach for high quality TV services. Due to the interactive nature of the IP network, user channel viewing statistics can be collected in real-time fashion.

Such a system typically consist of head-ends that sends encoded digital TV signals into the IP network as multicast streams, Set-Top-Boxes (STB) on the users'premises connecting to TV sets. At any given time, the STBs can select one of the multicast streams and decode the digital signals and send TV signals to an attached TV set.

It is therefore desirable to collect the current statistics of channel viewing available through the STB, formulate the data by demographic or other indicia and present the data substantially real-time to advertising contacts, provide support functions for auctions of advertising time blocks on a substantially real time basis for bid by the advertisers based on the statistics, and insert advertising media into the transmission stream based on the winning bid.

### SUMMARY OF THE INVENTION

The present invention provides a system for real time auctioning of advertising timeslots for live TV transmission over IP networks. The system incorporates settop boxes interconnected to a server to provide real time viewing statistics to an advertising management system which also recieves subscriber information from a subscriber management system. The advertising management system determines demographics responsive to the subscriber information and viewing statistics and publishes advertising timeslot information and the determined demographics. A management terminal is employed for creating user accounts and providing access information to users. The management terminal also is employed for inspecting and approving advertisements responsive to input of said advertisements from said users. Bid parameters are defined using the management terminal and the publication by the system to the users is responsive to the bid parameters. User terminals are provided for uploading advertisements to the advertising management system and the advertising management system further assigns unique identification to the uploaded advertisements. The user terminals upload advertising parameters, receive the published time slots and demographics and submit bids to the advertising management system. The advertising management system recieves the bids and inserts predefined advertisements responsive to a winning bid.

### BRIEF DESCRIPTION OF THE DRAWINGS

These and other features and advantages of the present invention will be better understood by reference to the following detailed description when considered in connection with the accompanying drawings wherein:

FIG. 1 is a block diagram of the elements of network system for multi-media streaming in which the present invention is employed;

FIG. 2 is a block diagram of the elements of the Advertisement Management System (AMS);

FIG. 3 is a flow chart of the entry flow for advertising data into the AMS; and,

FIG. 4 is a flow chart of the data flow of the bidding process and distribution of advertising data to the Media Distribution System.

### DETAILED DESCRIPTION OF THE INVENTION

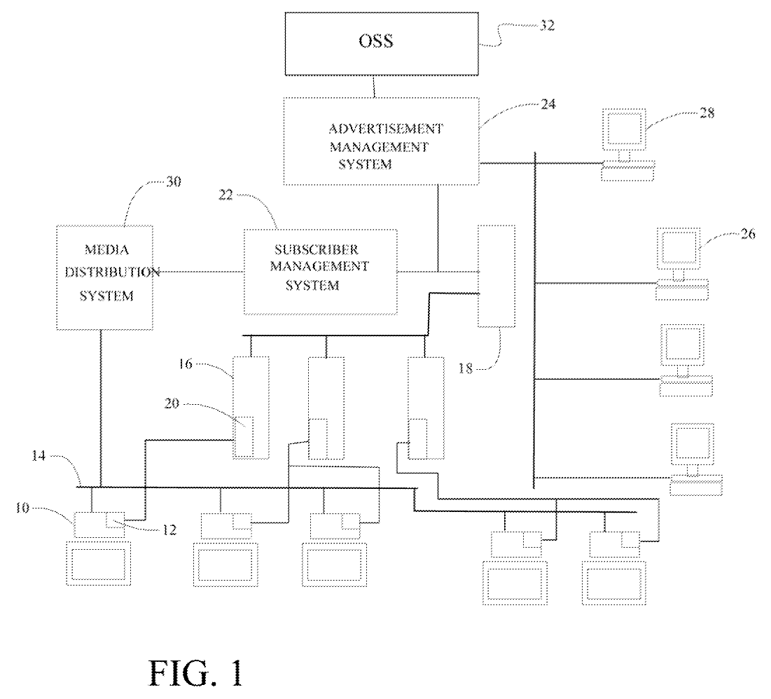

FIG. 1 shows a network system incorporating the elements of the present invention. On set top box (STB) 10, a software module 12 is employed to detect the current TV channel or channels (in case of Picture-in-Picture, or a STB receives and decodes multiple channels at the same time), as well as predetermined statistics such as channel change frequencies and timing. The data is sent over network connection 14 to a collection server 16 on the network, in a real-time fashion with configurable intervals.

A collection server can be a stand-alone server or a software module running on a machine that also runs other applications. The collection server receives channel viewing data from STBs on the network. For large deployment, a system incorporating the present invention employs a number of collection servers forming a hierarchy. The data is then funneled to a central server 18.

A security system 20 is employed to ensure the authenticity of the STB messages received by the collection server. An exemplary security approach is comparable to that defined in copending patent application Ssr. No. ______ carrying attorney docket no. U001 100248 and entitled Methods and Apparatus for Message Security in an IPTV Environment having a common assignee with the present application, the disclosure of which is incorporated herein by reference. Security system 20 authenticates an STB and issues tokens for the STB to access other components of the IPTV environment whereby the messages from this STB to the collection server are authenticated by the system.

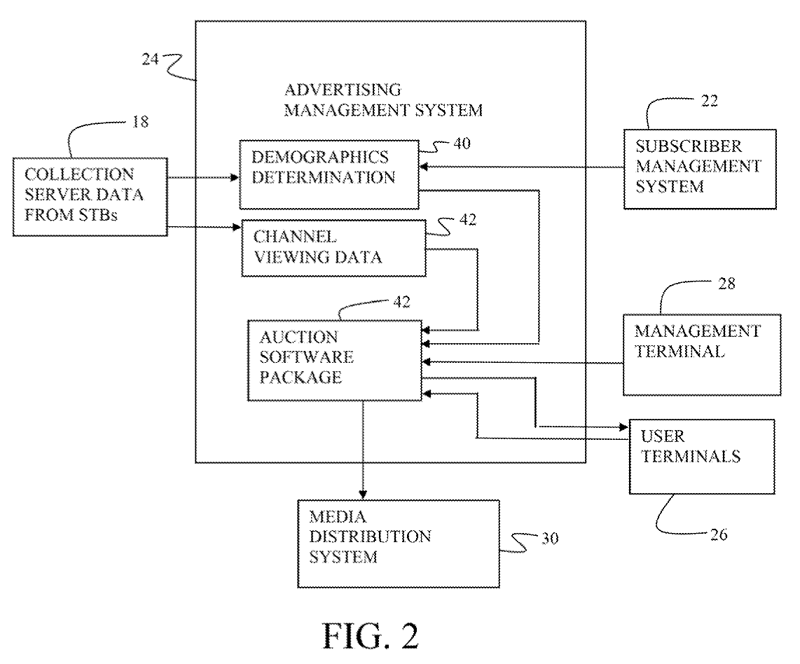

The central server records statistical data for all channels presented to viewers over the network. The viewing statistics are analyzed in conjunction with a subscriber management system 22. As shown in FIG. 2, the viewing statistics are provided from the server to Advertising Management System 24 with input form the subscriber management system to extract user demographics 40. The central server formulates the data to add demographic information to the channel viewing statistics 42. The formulated data is sent to an auction software package 44 in the advertising management system. The auction software displays the channel statistics, the current programs running on the channels, and the advertising time slots available on the channels as received from a Management terminal 28 to a plurality of user terminals 26 connected to the network. A user interface, either as a local application or a web-based application, is implemented on the terminals allowing a bidder to view all the available viewing statistic data, price, etc., and make inputs for bids on open advertising time slots.

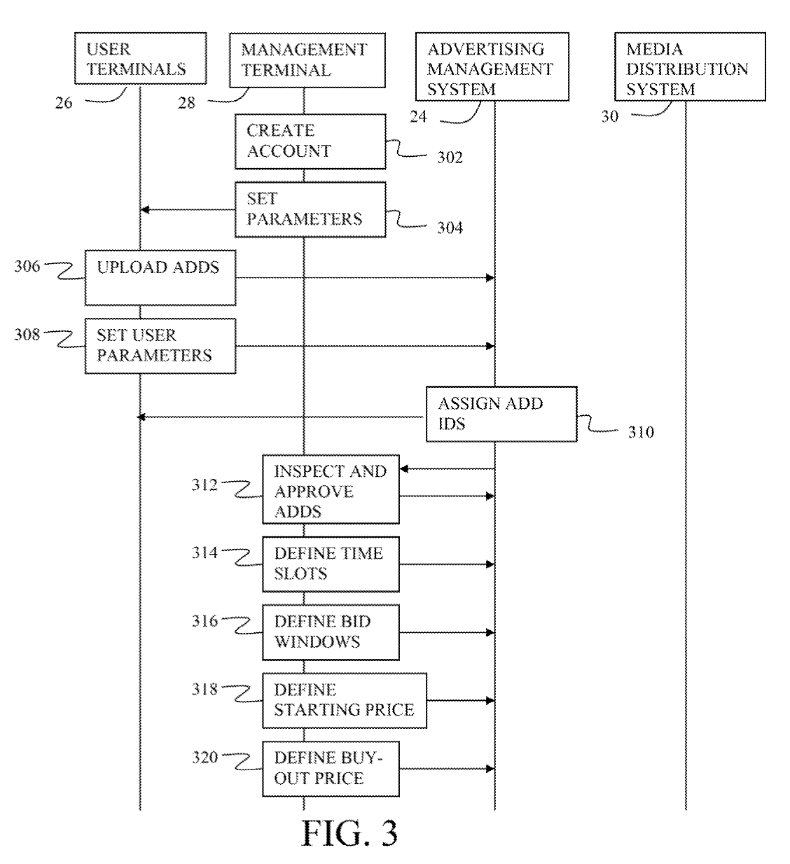

The advertisement management system is incorporated in the network. Through interactive operation on the management terminal an operator creates an account for a potential advertiser 302, sets the account parameters 304, such as username and password, payment related information, etc. as shown in FIG. 3. Potential advertisers upload their ads 306, and set parameters 308 such as categories, excluded TV programs or type of programs, excluded time slots, etc. through the advertisement management system. Unique IDs are assigned to the ads 310 for identification to media distribution system 30.

The user interfaces and the management terminal include a video subsystem and are employed for inspecting and approving the ads 312 for use in the network by the operator. The management terminal interface also allows the operator to add and remove ad time slots 314, set the bidding time windows 316, det starting price 318, buy-out price 320, and other applicable parameters.

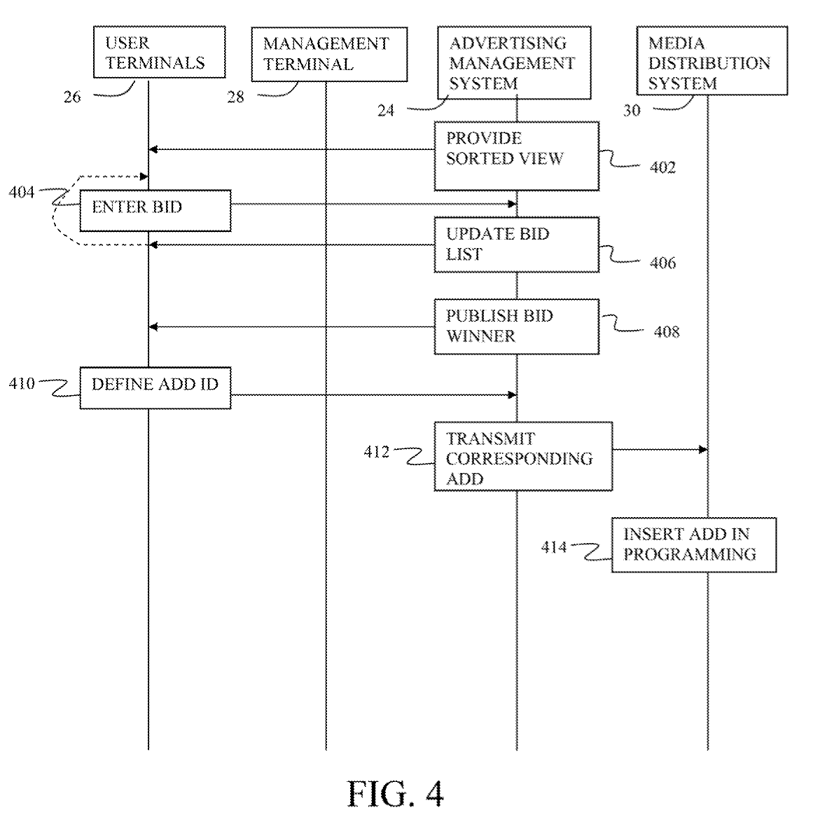

As shown in FIG. 4, the Advertisement Management system correlates the add information with corresponding program information to provide a sorted view 402 of available advertising slots consistent with the ad criteria allowing the users to easily identify available slots for their ads. During the bidding window, users enter bids for the available time slots 404 with updated bids appearing 406 on all interested users terminals. The high bidder at the predetermined bid close for the ad slot will secure that slot 408 and define the selected ad through the ID number to the system 410. The Advertisement Management System will the transmit 412 the previoulsy entered advertisement corresponding to that ID through the network to Media Distribution System 30 which will insert the advertisement into the timeslot in the multicast programming 414. Actual advertisement insertion will be implemented by an insertion engine and MPEG-2 splicer, which are commercially available products know to those skilled in the art. A backend Operation Support System (OSS) 32, shown in FIG. 1, keeps track of all transactions, users, and handles all billing operations.

Having now described the invention in detail as required by the patent stautes, those skilled in the art will recognize modifications and substitutions to the specific embodiments disclosed herein. Such modifications are within the scope and intent of the present invention as defined in the following claims.

What is claimed is:

1. A system for real time television advertisement auction comprising:
settop boxes interconnected to a server to provide real time viewing statistics;
an advertising management system receiving viewing statistics from the server and subscriber information from a subscriber management system and having
means for demographics determination responsive to the subscriber information and viewing statistics;
means for publishing advertising timeslot inforation and determined demographics;
means for reciving bids responsive to the published information;
means for inserting predefined advertisements responsive to a winning bid.

2. A system as defined in claim 1 further comprising a management terminal having
means for creating user accounts and providing access information to users;
means for inspecting and approving advertisements responsive to input of said advertisements from said users; and,
means for defining bid parameters, said publishing means responsive to the bid parameters.

3. A system as defined in claim 2 wherein the means for defining bid parameters includes means for defining advertising time slots.

4. A system as defined in claim 2 wherein the means for defining bid parameters includes means for defining bid windows.

5. A system as defined in claim 2 wherein the means for defining bid parameters includes means for defining starting price.

6. A system as defined in claim 2 wherein the means for defining bid parameters includes means for defining buyout price.

7. A system as defined in claim 2 further comprising user terminals having
means for uploading advertisements to the advertising management system, the means for inspecting and approving responsive to said uploading means and the advertising management system further including means for assigning unique identification to the uploaded advertisements;
means for uploading advertising parameters;
means for receiving output of the publishing means; and,
means for submitting bids to the receiving means.

8. A sytem as defined in claim 7 wherein the advertising management system further includes means for notifying the winning bidder and the user terminal further includes means for submitting an advertisement identification responsive to a winning bit notification, the inserting means responsive to the advertisement identification and providing an output to a media distribution system for insertion of the advertisement corresponding to the advertisement identification.

9. A system as defined in claim 1 further comprising security means for verification of authenticity of settop box viewing statistics.

10. A method for real time television advertisement auction comprising the steps of:
interconnecting settop boxes to a server to provide real time viewing statistics;
receiving viewing statistics from the server and subscriber information from a subscriber management system;
determining demographics responsive to the subscriber information and viewing statistics;
publishing advertising timeslot information and determined demographics;
receiving bids responsive to the published information;
inserting predefined advertisements responsive to a winning bid.

11. A method as defined in claim 10 further comprising the preliminary steps of:
creating user accounts and providing access information to users;
inspecting and approving advertisements responsive to input of said advertisements from said users; and,
defining bid parameters, the step of publishing being responsive to the bid parameters.

12. A method as defined in claim 11 wherein the step of defining bid parameters includes defining advertising time slots.

13. A method as defined in claim 11 wherein the step of defining bid parameters includes defining bid windows.

14. A method as defined in claim 11 wherein the step of defining bid parameters includes defining starting price.

15. A method as defined in claim 11 wherein the step of defining bid parameters includes defining buyout price.

16. A method as defined in claim 11 wherein user terminasls accomplish further steps of:
uploading advertisements to the advertising management system, the means for inspecting and approving responsive to said uploading means and the advertising management system further including means for assigning unique identification to the uploaded advertisements;
uploading advertising parameters;
receiving output of the publishing means; and,
submitting bids to the receiving means.

17. A method as defined in claim 16 further including the step of notifying the winning bidder and the user terminal further accomplishes the step of submitting an advertisement indentification responsive to a winning bit notification, the step of inserting being responsive to the advertisement identification and providing an output to a media distribution system for insertion of the advertisement corresponding to the advertisement identification.

18. A system as defined in claim 10 further comprising the step of verifying authenticity of settop box viewing statistics.
